(19) United States
(12) Patent Application Publication
(10) Pub. No.: US 2026/0371374 A1
(43) Pub. Date: Nov. 19, 2026

(54) SWITCHING BETWEEN DISCRETE AND MODULAR ANTENNA MODES

(71) Applicant: QUALCOMM Incorporated, San Diego, CA (US)

(72) Inventors: Vasanthan RAGHAVAN, West Windsor Township, NJ (US); Yu ZHANG, San Diego, CA (US); Jing SUN, San Diego, CA (US); Jing JIANG, San Diego, CA (US)

(21) Appl. No.: 19/210,845

(22) Filed: May 16, 2025

(51) Int. Cl. H04W 72/51; H01Q 1/24; H04B 7/08; H04L 5/00; H04W 72/232

(52) U.S. Cl. CPC H04W 72/51; H04B 7/088; H04L 5/0053; H04W 72/232; H01Q 1/246

(57) ABSTRACT

Various aspects of the present disclosure generally relate to wireless communication. In some aspects, a user equipment (UE) may transmit, to a network node, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications. The UE may receive, from the network node, a message indicating a switch between the discrete antenna mode and the modular antenna mode in accordance with the capability message. The UE may communicate with the network node in accordance with the switch between the discrete antenna mode and the modular antenna mode. Numerous other aspects are described.

### FIELD OF THE DISCLOSURE

Aspects of the present disclosure generally relate to wireless communication and specifically relate to techniques, apparatuses, and methods associated with switching between discrete and modular antenna modes.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to transmit, to a network node, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications. The processing system may be configured to cause the UE to receive, from the network node, a message indicating a switch between the discrete antenna mode and the modular antenna mode in accordance with the capability message. The processing system may be configured to cause the UE to communicate with the network node in accordance with the switch between the discrete antenna mode and the modular antenna mode.

Some aspects described herein relate to a network node. The network node may include a processing system. The processing system may include one or more processors and one or more code-storing memories coupled with the one or more processors. The processing system may be configured to cause the network node to receive, from a UE, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications. The processing system may be configured to cause the network node to transmit, to the UE, a message indicating a switch between the discrete antenna mode and the modular antenna mode in accordance with the capability message. The processing system may be configured to cause the network node to communicate with the UE in accordance with the switch between the discrete antenna mode and the modular antenna mode.

Some aspects described herein relate to a method of wireless communication performed by a UE. The method may include transmitting, to a network node, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications. The method may include receiving, from the network node, a message indicating a switch between the discrete antenna mode and the modular antenna mode in accordance with the capability message. The method may include communicating with the network node in accordance with the switch between the discrete antenna mode and the modular antenna mode.

Some aspects described herein relate to a method of wireless communication performed by a network node. The method may include receiving, from a UE, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications. The method may include transmitting, to the UE, a message indicating a switch between the discrete antenna mode and the modular antenna mode in accordance with the capability message. The method may include communicating with the UE in accordance with the switch between the discrete antenna mode and the modular antenna mode.

Some aspects described herein relate to a non-transitory computer-readable medium that stores a set of instructions for wireless communication by a UE. The set of instructions, when executed by one or more processors of the UE, may cause the UE to transmit, to a network node, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications. The set of instructions, when executed by one or more processors of the UE, may cause the UE to receive, from the network node, a message indicating a switch between the discrete antenna mode and the modular antenna mode in accordance with the capability message. The set of instructions, when executed by one or more processors of the UE, may cause the UE to communicate with the network node in accordance with the switch between the discrete antenna mode and the modular antenna mode.

Some aspects described herein relate to a non-transitory computer-readable medium that stores a set of instructions for wireless communication by a network node. The set of instructions, when executed by one or more processors of the network node, may cause the network node to receive, from a UE, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications. The set of instructions, when executed by one or more processors of the network node, may cause the network node to transmit, to the UE, a message indicating a switch between the discrete antenna mode and the modular antenna mode in accordance with the capability message. The set of instructions, when executed by one or more processors of the network node, may cause the network node to communicate with the UE in accordance with the switch between the discrete antenna mode and the modular antenna mode.

Some aspects described herein relate to an apparatus for wireless communication. The apparatus may include means for transmitting, to a network node, a capability message indicating support for switching between a discrete antenna mode and a modular antenna mode, wherein the discrete antenna mode is associated with using one or more discrete antennas of the apparatus for communications and the modular antenna mode is associated with using one or more antenna elements in an antenna module of the apparatus for communications. The apparatus may include means for receiving, from the network node, a message indicating a switch between the discrete antenna mode and the modular antenna mode in accordance with the capability message. The apparatus may include means for communicating with the network node in accordance with the switch between the discrete antenna mode and the modular antenna mode.

Some aspects described herein relate to an apparatus for wireless communication. The apparatus may include means for receiving, from a UE, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications. The apparatus may include means for transmitting, to the UE, a message indicating a switch between the discrete antenna mode and the modular antenna mode in accordance with the capability message. The apparatus may include means for communicating with the UE in accordance with the switch between the discrete antenna mode and the modular antenna mode.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of using beams for communications between a network node and a user equipment (UE).

FIG. 3 is a diagram illustrating an example associated with switching between discrete and modular antenna modes.

FIG. 4 is a diagram illustrating an example process performed, for example, at a UE or an apparatus of a UE.

FIG. 5 is a diagram illustrating an example process performed, for example, at a network node or an apparatus of a network node.

FIG. 6 is a diagram of an example apparatus for wireless communication.

FIG. 7 is a diagram of an example apparatus for wireless communication.

### DETAILED DESCRIPTION

Wireless communication devices, such as a user equipment (UE), may incorporate antennas to facilitate communication with other devices, such as one or more network nodes. In some cases, different designs and configurations of these antennas may impact communication performance, signal quality, and operational flexibility. For example, discrete uni-polarized (e.g., planar inverted F antennas) antennas may have a quasi-omnidirectional elemental or radiation pattern, and may be suited for UEs which have a constraint in terms of real estate to accommodate dual-polarized antenna elements. Accordingly, in some cases, discrete antennas may be used in relatively lower frequency ranges, such as FR1 (e.g., frequencies below 7.125 GHz), or in FR3 (e.g., frequencies between 7.125 GHz and 24.25 GHz). Conversely, in higher frequency ranges (e.g., FR2 which are beyond 24.25 GHz), modular antennas may be used, which consist of one or more arrays of multiple dual-polarized antenna elements. These antenna elements in a module (or panel) share a common ground plane and a common boresight (e.g., peak radiation) direction allowing the UE to co-phase these antenna elements for link budget improvements on either the downlink or uplink operations. In some cases, modular antennas may provide enhanced array gain, support dual-polarization, and allow for narrow beamwidth beamforming to improve link margin and peak signal performance and interference mitigation.

In some cases, a UE may be equipped with multiple types of antennas, such as modular antennas and discrete antennas. For example, operation at frequency ranges around 13 GHz may allow the design of both modular and discrete antennas that can be simultaneously placed in the UE. Accordingly, the UE may use different types of antennas when the UE communicates in different frequency ranges, and the UE may experience the advantages of both antenna types when operating in the different frequency ranges. In some examples, to further improve communications, it may be beneficial to configure the UE to switch between antenna types when operating in a single frequency range.

In some cases, however, managing antenna type switches in mixed antenna designs may be associated with various challenges. For example, effective communication may require dynamic switching between discrete antennas and modular antennas, which may be based on channel conditions, rank requirements, or other operational parameters. Additionally, discrete-to-modular and modular-to-discrete antenna switching processes may be asymmetric and may be associated with different time durations to perform each switch due to the distinct nature of radio frequency (RF) architectures, hardware designs, and antenna and RF component placements within the UE. While the UE may be configured to report some capabilities for beam switching within antenna modules (e.g., information elements like timeDurationForQCL and maxNumberRxTxBeamSwitchDL), these capabilities may be limited to switching between beams within a single modular antenna (e.g., at FR2) and may not account for the unique challenges associated with switching between discrete and modular antennas. Additionally, because switching between different antenna types may be associated with different delays associated with antennas, antenna type switching may disrupt communication and introduce latency, particularly when the switching delays are not well-coordinated between the UE and the network node.

Various aspects relate generally to enabling dynamic switching between discrete and modular antenna modes in wireless communication systems. Some aspects more specifically relate to configuring a UE to transmit a capability message to a network node indicating support for switching between a discrete antenna mode and a modular antenna mode. The discrete antenna mode may correspond to using one or more discrete antennas of the UE for communications, and the modular antenna mode may correspond to using one or more antenna elements in an antenna module (or panel) of the UE for communications. The UE may be configured to operate dynamically in either mode based on a received message or configuration from the network node, and the UE may communicate with the network node accordingly. For example, the UE may receive a transmission configuration indicator (TCI) state configuration that defines multiple substates for each TCI state, where a first substate may correspond to the discrete antenna mode and a second substate may correspond to the modular antenna mode, and the UE may switch between the modes dynamically based on an indicated TCI state and TCI substate. Additionally, or alternatively, the TCI state configuration may indicate multiple TCI state lists, where a first TCI state list may correspond to the discrete antenna mode and a second TCI state list may correspond to the modular antenna mode. In some aspects, the capability message may indicate time durations for the UE to switch between the antenna modes, and the network node may schedule communication resources effectively to allow for the UE to switch between the modular antenna mode and the discrete antenna mode. Additionally, or alternatively, the capability message may include a quantity of discrete antennas, modular antennas, or antenna elements of the UE. In some aspects, the network node may transmit one or more reference signals (e.g., via a control resource set (CORESET)) for the UE to perform antenna mode switching. For example, the UE may measure the one or more reference signals while operating in at least one antenna mode, and the UE may select an antenna mode for communications based on one or more reference signal received power (RSRP) thresholds or other criteria (e.g., signal quality) associated with the measurement.

Particular aspects of the subject matter described in this disclosure can be implemented to realize one or more of the following advantages. By enabling the UE to transmit capability information and dynamically switch between discrete and modular antenna modes, the described techniques may improve antenna utilization and communication efficiency. For example, discrete antennas may be preferred under high-rank conditions, offering better spatial diversity, while modular antennas may provide enhanced array gain under low-rank conditions. Alternately, modular antennas may be preferred for range extension on uplink or downlink operations. The ability to adaptively switch between these antenna modes may improve communication performance across varying channel conditions and operational scenarios. Additionally, by allowing the network node to configure TCI states, substate lists, and switching times or time durations based on the capabilities reported by the UE, the described techniques may reduce disruptions associated with switching delays and configure resources for the UE to operate in an indicated antenna mode. Furthermore, mechanisms to handle asymmetric switching times and dynamic antenna modes address challenges associated with supporting emerging frequency bands (e.g., FR3 bands, which may be used in Sixth Generation (6G) technologies), which may benefit from mixed antenna designs. In this way, the techniques may conserve processing resources, memory resources, or network resources by streamlining antenna mode switching processes and communication scheduling to facilitate efficient resource allocation.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, RF sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

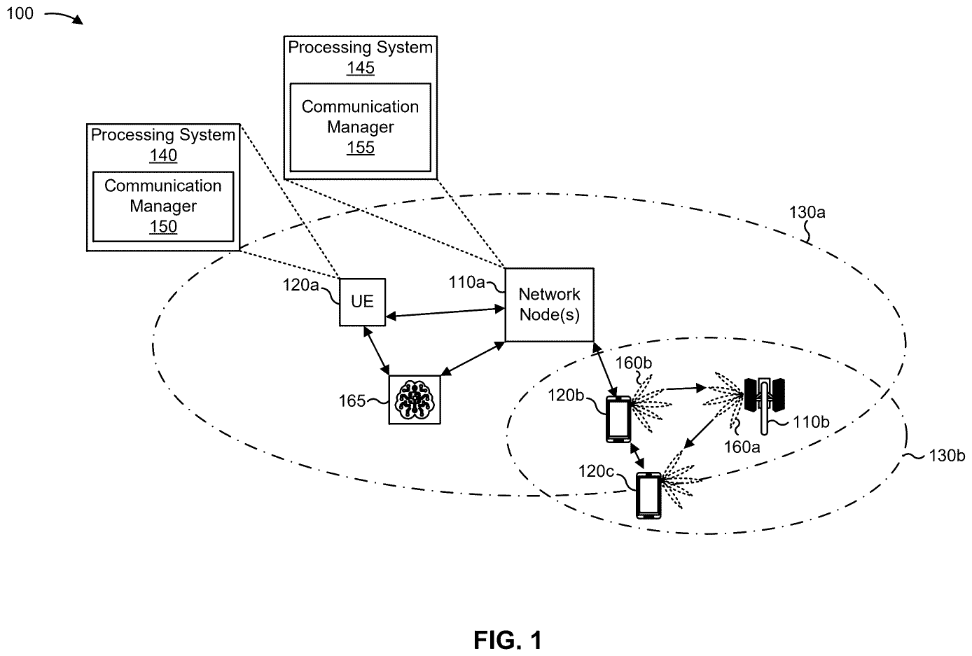

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-RSRP parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a TCI state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may transmit, to a network node 110, a capability message indicating support for switching between a discrete antenna mode and a modular antenna mode, wherein the discrete antenna mode is associated with using one or more discrete antennas of the UE 120 for communications and the modular antenna mode is associated with using one or more antenna elements in an antenna module of the UE 120 for communications; receive, from the network node 110, a message indicating a switch between the discrete antenna mode and the modular antenna mode in accordance with the capability message; and communicate with the network node 110 in accordance with the switch between the discrete antenna mode and the modular antenna mode. Additionally, or alternatively, the communication manager 150 may perform one or more other operations described herein.

In some aspects, the network node 110 may include a communication manager 155. As described in more detail elsewhere herein, the communication manager 155 may receive, from a UE 120, a capability message indicating support for switching between a discrete antenna mode and a modular antenna mode, wherein the discrete antenna mode is associated with using one or more discrete antennas of the UE 120 for communications and the modular antenna mode is associated with using one or more antenna elements in an antenna module of the UE 120 for communications; transmit, to the UE 120, a message indicating a switch between the discrete antenna mode and the modular antenna mode in accordance with the capability message; and communicate with the UE 120 in accordance with the switch between the discrete antenna mode and the modular antenna mode. Additionally, or alternatively, the communication manager 155 may perform one or more other operations described herein.

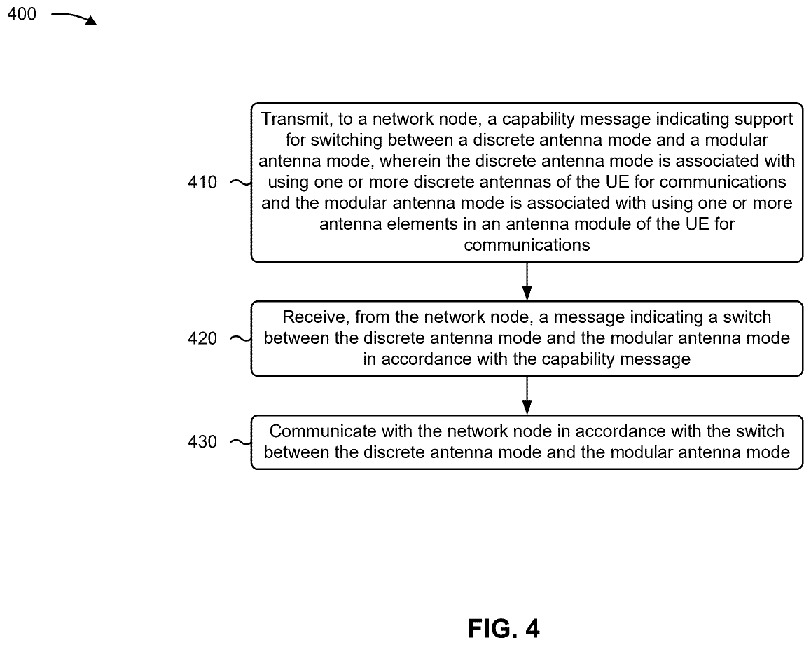

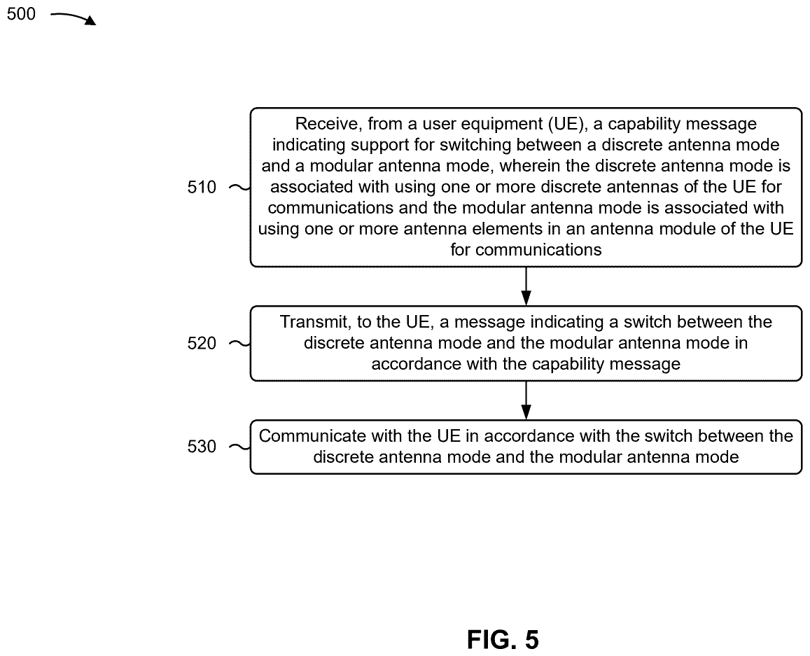

The network node 110, the processing system 145 of the network node 110, the UE 120, the processing system 140 of the UE 120, or any other component(s) of FIG. 1 may implement one or more techniques or perform one or more operations associated with switching between discrete and modular antenna modes, as described in more detail elsewhere herein. For example, the processing system 145 of the network node 110, or the processing system 140 of the UE 120 may perform or direct operations of, for example, process 400 of FIG. 4, process 500 of FIG. 5, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 400 of FIG. 4, process 500 of FIG. 5, or other processes as described herein. In some examples, executing instructions may include running the instructions, converting the instructions, compiling the instructions, or interpreting the instructions, among other examples.

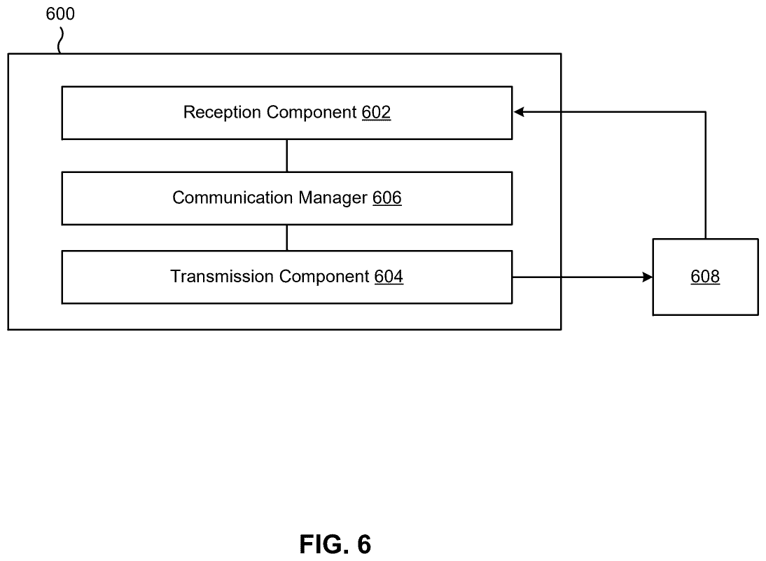

In some aspects, the UE 120 includes means for transmitting, to a network node 110, a capability message indicating support for switching between a discrete antenna mode and a modular antenna mode, wherein the discrete antenna mode is associated with using one or more discrete antennas of the UE 120 for communications and the modular antenna mode is associated with using one or more antenna elements in an antenna module of the UE 120 for communications; means for receiving, from the network node 110, a message indicating a switch between the discrete antenna mode and the modular antenna mode in accordance with the capability message; or means for communicating with the network node 110 in accordance with the switch between the discrete antenna mode and the modular antenna mode. The means for the UE 120 to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

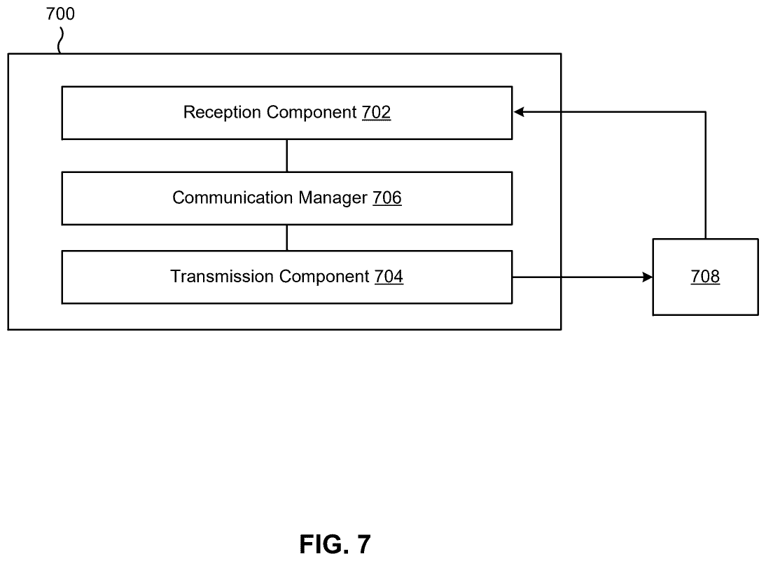

In some aspects, the network node 110 includes means for receiving, from a UE 120, a capability message indicating support for switching between a discrete antenna mode and a modular antenna mode, wherein the discrete antenna mode is associated with using one or more discrete antennas of the UE 120 for communications and the modular antenna mode is associated with using one or more antenna elements in an antenna module of the UE 120 for communications; means for transmitting, to the UE, a message indicating a switch between the discrete antenna mode and the modular antenna mode in accordance with the capability message; or means for communicating with the UE 120 in accordance with the switch between the discrete antenna mode and the modular antenna mode. The means for the network node 110 to perform operations described herein may include, for example, one or more of communication manager 155, processing system 145, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

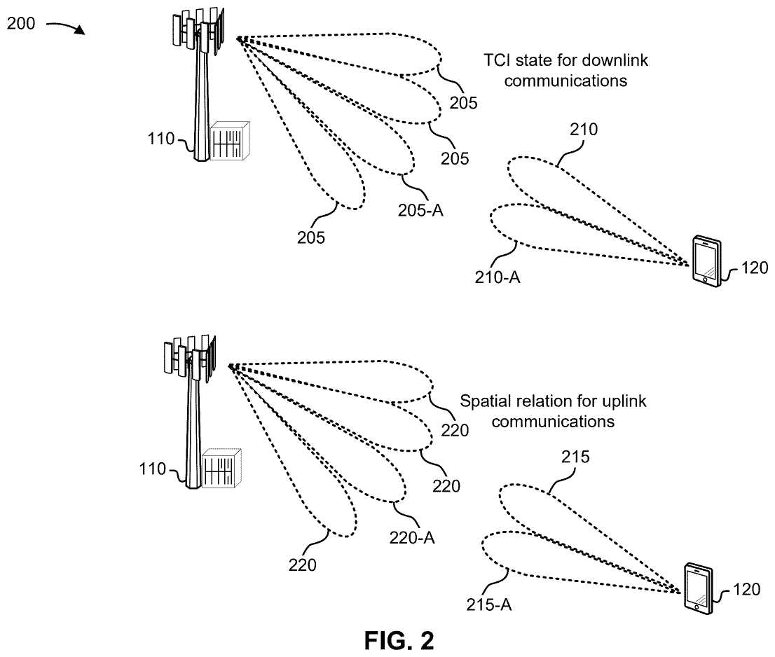

FIG. 2 is a diagram illustrating an example 200 of using beams for communications between a network node and a UE. As shown in FIG. 2, a network node 110 and a UE 120 may communicate with one another.

The network node 110 may transmit to UEs 120 located within a coverage area of the network node 110. The network node 110 and the UE 120 may be configured for beamformed communications, where the network node 110 may transmit in the direction of the UE 120 using a directional network node transmit beam, and the UE 120 may receive the transmission using a directional UE receive beam. Each network node transmit beam may have an associated beam ID, beam direction, or beam symbols, among other examples. The network node 110 may transmit downlink communications via one or more network node transmit beams 205.

The UE 120 may attempt to receive downlink transmissions via one or more UE receive beams 210, which may be configured using different beamforming parameters at receive circuitry of the UE 120. The UE 120 may identify a particular network node transmit beam 205, shown as network node transmit beam 205-A, and a particular UE receive beam 210, shown as UE receive beam 210-A, that provide relatively favorable performance (for example, that have a best channel quality of the different measured combinations of network node transmit beams 205 and UE receive beams 210). In some examples, the UE 120 may transmit an indication of which network node transmit beam 205 is identified by the UE 120 as a preferred network node transmit beam, which the network node 110 may select for transmissions to the UE 120. The UE 120 may thus attain and maintain a beam pair link (BPL) with the network node 110 for downlink communications (for example, a combination of the network node transmit beam 205-A and the UE receive beam 210-A), which may be further refined and maintained in accordance with one or more established beam refinement procedures.

A downlink beam, such as an network node transmit beam 205 or a UE receive beam 210, may be associated with a TCI state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each network node transmit beam 205 may be associated with a synchronization signal block (SSB), and the UE 120 may indicate a preferred network node transmit beam 205 by transmitting uplink transmissions in resources of the SSB that are associated with the preferred network node transmit beam 205. A particular SSB may have an associated TCI state (for example, for an antenna port or for beamforming). The network node 110 may, in some examples, indicate a downlink network node transmit beam 205 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 210 at the UE 120. Thus, the UE 120 may select a corresponding UE receive beam 210 from a set of BPLs based at least in part on the network node 110 indicating an network node transmit beam 205 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a PDSCH. The set of activated TCI states for downlink control channel communications may correspond to beams that the network node 110 may use for downlink transmission on a PDCCH or in a CORESET. The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the network node 110 using a directional UE transmit beam, and the network node 110 may receive the transmission using a directional network node receive beam. Each UE transmit beam may have an associated beam ID, beam direction, or beam symbols, among other examples. The UE 120 may transmit uplink communications via one or more UE transmit beams 215.

The network node 110 may receive uplink transmissions via one or more network node receive beams 220. The network node 110 may identify a particular UE transmit beam 215, shown as UE transmit beam 215-A, and a particular network node receive beam 220, shown as network node receive beam 220-A, that provide relatively favorable performance (for example, that have a best channel quality of the different measured combinations of UE transmit beams 215 and network node receive beams 220). In some examples, the network node 110 may transmit an indication of which UE transmit beam 215 is identified by the network node 110 as a preferred UE transmit beam, which the network node 110 may select for transmissions from the UE 120. The UE 120 and the network node 110 may thus attain and maintain a BPL for uplink communications (for example, a combination of the UE transmit beam 215-A and the network node receive beam 220-A), which may be further refined and maintained in accordance with one or more established beam refinement procedures. An uplink beam, such as a UE transmit beam 215 or an network node receive beam 220, may be associated with a spatial relation. A spatial relation may indicate a directionality or a characteristic of the uplink beam, similar to one or more QCL properties, as described above.

In some aspects, the UE 120 may be configured to transmit a capability message to a network node 110 indicating support for switching between a discrete antenna mode and a modular antenna mode. The discrete antenna mode may correspond to using one or more discrete antennas of the UE 120 for communications, and the modular antenna mode may correspond to using one or more antenna elements in an antenna module of the UE 120 for communications. The UE 120 may be configured to operate dynamically in either mode based on a received message or configuration from the network node 110, and the UE 120 may communicate with the network node 110 accordingly. For example, the UE 120 may receive a TCI state configuration that defines multiple substates for each TCI state, where a first substate may correspond to the discrete antenna mode and a second substate may correspond to the modular antenna mode, and the UE 120 may switch between the modes dynamically based on an indicated TCI state and TCI substate. Additionally, or alternatively, the TCI state configuration may indicate multiple TCI state lists, where a first TCI state list may correspond to the discrete antenna mode and a second TCI state list may correspond to the modular antenna mode. In some aspects, the capability message may indicate durations for the UE 120 to switch between the antenna modes, and the network node 110 may schedule communication resources effectively to allow for the UE 120 to switch between the modular antenna mode and the discrete antenna mode. Additionally, or alternatively, the capability message may include a quantity of discrete antennas, modular antennas, or antenna elements of the UE 120. In some aspects, the network node 110 may transmit one or more reference signals (e.g., via a CORESET) for the UE 120 to perform antenna mode switching. For example, the UE 120 may measure the one or more reference signals while operating in at least one antenna mode, and the UE 120 may select an antenna mode for communications based on one or more RSRP thresholds or other criteria associated with the measurement.

As indicated above, FIG. 2 is provided as an example. Other examples may differ from what is described with respect to FIG. 2.

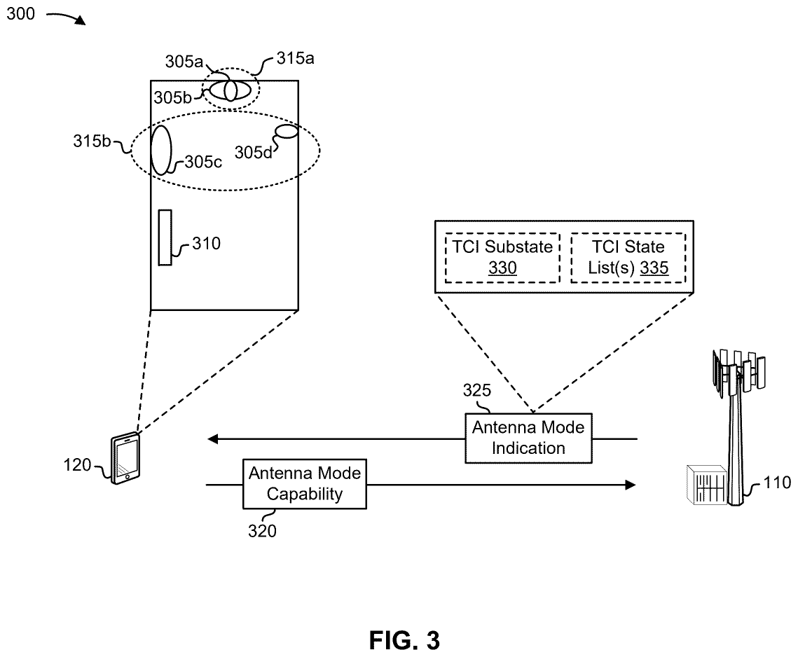

FIG. 3 is a diagram illustrating an example 300 associated with switching between discrete and modular antenna modes. As shown in FIG. 3, example 300 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

In some examples, the UE 120 may be equipped with different types of antennas to facilitate wireless communications. For example, the UE 120 may include one or more discrete antennas 305 and one or more antenna modules 310, as described herein. In some examples, the UE 120 may include a discrete antenna 305a, a discrete antenna 305b, a discrete antenna 305c, and a discrete antenna 305d. Additionally, the UE 120 may include an antenna module 310, which may include one or more groups (e.g., arrays) of antenna elements.

In some examples, to perform communications via one or more discrete antennas 305, the UE 120 may be configured to form virtual modules 315. A virtual module 315 may include a combination of multiple discrete antennas 305. For example, the UE 120 may communicate via a virtual module 315a that may include the discrete antenna 305a and the discrete antenna 305b, or a virtual module 315b that includes the discrete antenna 305c and the discrete antenna 305d. Accordingly, the use of virtual modules 315 including a static combination of discrete antennas 305 may provide a balanced trade-off in communication performance and cost between using solely modular or discrete antenna configurations.

In some aspects, the UE 120 may transmit (e.g., using communication manager 150 or processing system 140), and the network node 110 may receive, an indication of an antenna mode capability 320 (e.g., as part of a capability exchange or negotiation). The antenna mode capability 320 may indicate one or more antenna modes supported by the UE 120, such as a discrete antenna mode corresponding to using one or more discrete antennas 305 (or virtual modules 315) for communications and a modular antenna mode corresponding to using the antenna module 310 for communications. Additionally, or alternatively, the antenna mode capability 320 may indicate a quantity of the discrete antennas 305 and antenna modules 310 of the UE 120, which may (e.g., implicitly) indicate the antenna modes supported by the UE 120 to the network node 110.

In some aspects, the antenna mode capability 320 may indicate whether the UE 120 supports one or more antenna modes for each quasi co-located reference signal source corresponding to one or more reference signals transmitted by the network node 110 and measured by the UE 120. For example, for some quasi co-located reference signal sources, the use of the antenna modules for communications may be beneficial, such as in scenarios associated with lower rank channels (e.g., PDSCHs) due to higher effective isotropic radiated power (EIRP) gains in low rank channels. Conversely, for higher rank channels, discrete antennas may be beneficial, as discrete antennas may provide improved spatial diversity and may support transmissions over multiple clusters or propagation paths in the channel relative to modular antennas. Accordingly, the network node 110 may perform beamforming and resource scheduling in accordance with the antenna mode capability 320, thereby enhancing communication efficiency and performance across varying channel conditions and operational scenarios.

In some aspects, to indicate different antenna modes for the UE 120, the network node 110 may configure (e.g., using communication manager 155 or processing system 145) TCI states for the UE 120 in accordance with the antenna modes supported by the UE 120. For example, the network node 110 may configure two TCI substates 330 for each TCI state, where a first TCI substate 330 of a TCI state corresponds to communications using one or more discrete antennas 305 and a second TCI substate 330 of the TCI state corresponds to communications using the antenna module 310. In some examples, both TCI substates 330 of a TCI state may correspond to a same quasi co-located reference signal source. Additionally, or alternatively, the network node 110 may configure two TCI state lists 335, each including one or more TCI states. In some aspects, a first TCI state list 335 may include one or more TCI states corresponding to communications using one or more discrete antennas 305, and a second TCI state list 335 may include one or more TCI states corresponding to communications using the antenna module 310.

In some aspects, to indicate whether the UE 120 supports one or more antenna modes, the antenna mode capability 320 may indicate whether the UE 120 supports one or two TCI substates 330, or one or two TCI state lists 335. For example, the UE 120 may indicate whether the UE 120 supports one or two TCI states for each quasi co-located reference signal source. Accordingly, the multiple TCI substates 330 or TCI state lists 335 may support the discrete antenna mode, and the modular antenna mode for each beam that may be used by the network node 110. Additionally, the network node 110 may implement separate TCI substates 330 or TCI state lists 335 for downlink and uplink operations (e.g., within a same slot). Accordingly, the network node 110 may configure the UE 120 to switch antenna modes or use different antenna modes for downlink and uplink independently, which may allow the UE 120 and the network node 110 to adapt to changing uplink and downlink channel conditions.

In some aspects, the network node 110 may transmit, and the UE 120 may receive, an antenna mode indication 325, which may indicate an antenna mode to be used by the UE 120. In some examples, the antenna mode indication 325 may be included in a downlink grant, where the network node 110 may indicate one or more resources for an uplink or a downlink communication. For example, the network node 110 may transmit the downlink grant that explicitly or implicitly indicates the antenna mode. In some examples, the downlink grant may indicate a TCI state and a TCI substate 330 corresponding to an antenna mode to be used, or the network node may indicate a TCI state from a TCI state list 335 corresponding to the antenna mode to be used, which may be examples of an explicit indication of the antenna mode. Additionally, or alternatively, the network node 110 may indicate an RI which may indicate the antenna mode, which may be an example of an implicit indication. For example, the UE 120 may be configured to select the modular antenna mode when the RI corresponds to low rank conditions and the discrete antenna mode when the RI corresponds to high rank conditions (e.g., based on the RI satisfying one or more thresholds). When the network node 110 indicates (e.g., explicitly or implicitly) an antenna mode that is different from a current antenna mode that the UE 120 is using for communications, the UE 120 may switch between antenna modes (e.g., between the modular antenna mode and the discrete antenna mode).

Accordingly, the UE 120 may switch between the discrete antenna mode and the modular antenna mode based on which antenna mode was indicated by the network node 110. In some examples, a time duration for the UE 120 to switch between the discrete antenna mode and the modular antenna mode may vary, and the network node 110 may configure communications with the UE 120 accounting for the duration for the UE 120 to perform the switch (e.g., by configuring sufficient gap periods). In some cases, the time duration required for discrete-to-modular antenna switching and modular-to-discrete antenna switching may differ, and the UE 120 may indicate both durations (e.g., via the antenna mode capability 320) to the network node 110 so that the network node 110 may configure communications according to the appropriate duration corresponding to the indicated antenna mode switch. The time duration for switching may also vary from one module to another module, and may also vary from one discrete antenna to another discrete antenna. For example, the time to switch from a first module to a first discrete antenna may be different from the time to switch from a second module to a second discrete antenna. In some examples, the durations may be indicated as an absolute time duration (e.g., in microseconds) or in a quantity of symbols (e.g., quantity of OFDM symbols), where the quantity of symbols may be relative to an SCS configured for multicarrier communications between the UE 120 and the network node 110.

In some examples, the network node 110 and the UE 120 may support CORESET-based antenna mode switching. For example, the network node 110 may configure one or more CORESETs (e.g., 1+N CORESETs, where N is a quantity of analog beams for the antenna module 310) based on the one or more TCI states. For example, a first CORESET may correspond to discrete antennas (e.g., may be intended for measurement via the one or more discrete antennas 305) and the remaining N CORESETs may correspond to the antenna module 310 (e.g., for measurement via the antenna module 310, with each CORESET corresponding to a respective analog beam).

In some aspects, when a PDSCH message is scheduled by a PDCCH within a CORESET, and the TCI substate 330 or TCI state list 335 of the PDSCH message corresponds to the same antenna mode as the TCI substate 330 or TCI state list 335 used for the CORESET, then no antenna switching time is configured by the network node 110. Alternatively, when the TCI substate 330 or TCI state list 335 for the CORESET and the PDSCH message correspond to different antenna switching modes, then the network node 110 may configure a gap between the PDCCH and the PDSCH that is at least as long as the corresponding switching duration that may be indicated by the UE 120.

For example, when the CORESET corresponds to the modular antenna mode and the PDSCH message corresponds to the discrete antenna mode, the network node 110 may configure the gap between the PDCCH and the PDSCH to be at least as long as a modular-to-discrete duration (e.g., t₁₀) indicated by the UE 120. Conversely, when the CORESET corresponds to the discrete antenna mode and the PDSCH message corresponds to the modular antenna mode, the network node 110 may configure the gap between the PDCCH and the PDSCH to be at least as long as a discrete-to-modular duration (e.g., t₀₁) indicated by the UE 120.

In some cases, if a gap between the PDCCH and PDSCH that is configured is insufficient for performing the antenna mode switch, the UE 120 may be configured to drop the downlink grant and not monitor for the PDSCH message. Additionally, or alternatively, the UE 120 may be configured to use the same TCI configured for the CORESET without switching antenna modes.

In some aspects, the UE 120 may measure one or more reference signals, such as a reference signal transmitted as part of a CORESET, to determine an antenna mode for communications. For example, the UE 120 may calculate an RSRP of one or more reference signals or a PDCCH of a CORESET associated with the discrete antenna mode. When the RSRP indicates favorable channel conditions (e.g., when the RSRP satisfies a first threshold), the UE 120 may select (e.g., using communication manager 150 or processing system 140) the discrete antenna mode for communications. Conversely, when the RSRP does not indicate favorable channel conditions (e.g., when the RSRP satisfies a second threshold or does not satisfy the first threshold), the UE 120 may use the modular antenna mode for communications. The UE 120 may perform a similar process when measuring signals from a CORESET associated with the modular antenna mode, and the UE 120 may perform antenna mode switching according to the measurements.

Additionally, or alternatively, the network node 110 may indicate an antenna mode switch via a BWP configuration. For example, when the network node 110 configures one or more BWPs, the network node 110 may indicate an antenna mode (e.g., by indicating a TCI substate 330 or a TCI state from a corresponding TCI state list) for each BWP. When the network node 110 schedules communications on a BWP, the UE 120 may use the antenna mode configured for the BWP. Accordingly, BWP-based switching may provide additional flexibility and efficiency, such as in scenarios where CORESET-based switching is constrained by time gaps.

In some aspects, the network node 110 may configure the UE 120 to transmit uplink communications in accordance with different antenna modes. For example, the network node 110 may configure multiple SRS resources associated with multiple SRS transmissions to be performed by the UE 120. In some aspects, the network node 110 may indicate a TCI state for each SRS resource or other spatial relation information (e.g., via a spatialRelationInfo information element). In some examples, the network node 110 may indicate a TCI substate 330 for each SRS resource, thereby indicating the antenna mode. Additionally, or alternatively, the TCI state list 335 that includes the TCI state may indicate the antenna mode.

In some cases, such as when the network node 110 configures the UE 120 with two TCI state lists 335 corresponding to the different antenna modes, the UE 120 may use discrete antennas 305 to transmit an SRS when the uplink TCI state of a corresponding SRS resource is from the TCI state list 335 associated with discrete antennas. Additionally, or alternatively, when the network node 110 configures TCI sub-states for each TCI state, uplink TCI states may be configured based on a default set of antenna types (e.g., antenna modules 310, discrete antenna 305, or virtual modules 315).

As indicated above, FIG. 3 is provided as an example. Other examples may differ from what is described with respect to FIG. 3.

FIG. 4 is a diagram illustrating an example process 400 performed, for example, at a UE or an apparatus of a UE. Example process 400 is an example where the apparatus or the UE (e.g., UE 120) performs operations associated with switching between discrete and modular antenna modes.

As shown in FIG. 4, in some aspects, process 400 may include transmitting, to a network node, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications (block 410). For example, the UE (e.g., using transmission component 604 or communication manager 606, depicted in FIG. 6) may transmit, to a network node, a capability message (e.g., antenna mode capability 320) indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications, as described above.

As further shown in FIG. 4, in some aspects, process 400 may include receiving, from the network node, a message (e.g., antenna mode indication 325) indicating a switch between the discrete antenna mode and the modular antenna mode in accordance with the capability message (block 420). For example, the UE (e.g., using reception component 602 or communication manager 606, depicted in FIG. 6) may receive, from the network node, a message indicating a switch between the discrete antenna mode and the modular antenna mode in accordance with the capability message, as described above.

As further shown in FIG. 4, in some aspects, process 400 may include communicating with the network node in accordance with the switch between the discrete antenna mode and the modular antenna mode (block 430). For example, the UE (e.g., using reception component 602, transmission component 604, or communication manager 606, depicted in FIG. 6) may communicate with the network node in accordance with the switch between the discrete antenna mode and the modular antenna mode, as described above.

Process 400 may include additional aspects, such as any single aspect or any combination of aspects described below or in connection with one or more other processes described elsewhere herein.

In a first aspect, process 400 includes receiving, from the network node, a TCI state configuration that indicates a TCI state and at least two substates (e.g., TCI substates 330) for the TCI state, wherein a first substate of the at least two substates corresponds to the discrete antenna mode and a second substate of the at least two substates corresponds to the modular antenna mode.

In a second aspect, alone or in combination with the first aspect, process 400 includes switching from the modular antenna mode to the discrete antenna mode in accordance with the message indicating the first substate of the TCI state.

In a third aspect, alone or in combination with one or more of the first and second aspects, process 400 includes switching from the discrete antenna mode to the modular antenna mode in accordance with the message indicating the second substate of the TCI state.

In a fourth aspect, alone or in combination with one or more of the first through third aspects, the first substate and the second substate both correspond to a same quasi co-located reference signal source.

In a fifth aspect, alone or in combination with one or more of the first through fourth aspects, process 400 includes receiving, from the network node, a TCI state configuration that indicates a first set of one or more TCI states (e.g., a first TCI state list 335) and a second set of one or more TCI states (e.g., a second TCI state list 335), wherein the first set of one or more TCI states corresponds to the discrete antenna mode and the second set of one or more TCI states corresponds to the modular antenna mode.

In a sixth aspect, alone or in combination with one or more of the first through fifth aspects, process 400 includes switching from the modular antenna mode to the discrete antenna mode in accordance with the message indicating a first TCI state of the first set of one or more TCI states.

In a seventh aspect, alone or in combination with one or more of the first through sixth aspects, process 400 includes switching from the discrete antenna mode to the modular antenna mode in accordance with the message indicating a first TCI state of the second set of one or more TCI states.

In an eighth aspect, alone or in combination with one or more of the first through seventh aspects, the capability message indicates a first duration for switching from the discrete antenna mode to the modular antenna mode and a second duration for switching from the modular antenna mode to the discrete antenna mode. In some examples, to indicate the first duration and the second duration, the capability message indicates one or more absolute time durations, one or more quantities of symbols associated with a subcarrier spacing, or a combination thereof.

In a ninth aspect, alone or in combination with one or more of the first through eighth aspects, process 400 includes receiving a PDCCH message via a CORESET corresponding to the discrete antenna mode, wherein the PDCCH message schedules a PDSCH message in accordance with the modular antenna mode, and receiving, from the network node after the first duration from receiving the PDCCH message, the PDSCH message while operating in the modular antenna mode.

In a tenth aspect, alone or in combination with one or more of the first through ninth aspects, process 400 includes receiving, from the network node, a PDCCH message via a CORESET corresponding to the modular antenna mode, wherein the PDCCH message schedules a PDSCH message in accordance with the discrete antenna mode, and receiving, from the network node after the second duration from receiving the PDCCH message, the PDSCH message while operating in the discrete antenna mode.

In an eleventh aspect, alone or in combination with one or more of the first through tenth aspects, process 400 includes receiving, from the network node, one or more reference signals via a CORESET corresponding to one of the discrete antenna mode or the modular antenna mode, and switching between the discrete antenna mode and the modular antenna mode in accordance with an RSRP associated with the one or more reference signals satisfying a threshold.

In a twelfth aspect, alone or in combination with one or more of the first through eleventh aspects, the capability message indicates at least one of a quantity of the one or more discrete antennas of the UE, and a quantity of the one or more antenna elements of the UE, or a quantity of one or more antenna modules of the UE.

In a thirteenth aspect, alone or in combination with one or more of the first through twelfth aspects, process 400 includes receiving, from the network node, a configuration indicating a plurality of SRS resources, wherein each SRS resource of the plurality of SRS resources corresponds to at least one of a respective uplink TCI state or a substate for the respective uplink TCI state, and transmitting, to the network node, an SRS via a first SRS resource of the plurality of SRS resources while operating in one of the modular antenna mode or the discrete antenna mode in accordance with at least one of a first TCI state corresponding to the first SRS resource or a substate of the first TCI state.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, at a network node or an apparatus of a network node. Example process 500 is an example where the apparatus or the network node (e.g., network node 110) performs operations associated with switching between discrete and modular antenna modes.

As shown in FIG. 5, in some aspects, process 500 may include receiving, from a UE, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications (block 510). For example, the network node (e.g., using reception component 702 or communication manager 706, depicted in FIG. 7) may receive, from a UE, a capability message (e.g., antenna mode capability 320) indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications, as described above.

As further shown in FIG. 5, in some aspects, process 500 may include transmitting, to the UE, a message (e.g., antenna mode indication 325) indicating a switch between the discrete antenna mode and the modular antenna mode in accordance with the capability message (block 520). For example, the network node (e.g., using transmission component 704 or communication manager 706, depicted in FIG. 7) may transmit, to the UE, a message indicating a switch between the discrete antenna mode and the modular antenna mode in accordance with the capability message, as described above.

As further shown in FIG. 5, in some aspects, process 500 may include communicating with the UE in accordance with the switch between the discrete antenna mode and the modular antenna mode (block 530). For example, the network node (e.g., using reception component 702, transmission component 704, or communication manager 706, depicted in FIG. 7) may communicate with the UE in accordance with the switch between the discrete antenna mode and the modular antenna mode, as described above.

Process 500 may include additional aspects, such as any single aspect or any combination of aspects described below or in connection with one or more other processes described elsewhere herein.

In a first aspect, process 500 includes transmitting, to the UE, a TCI state configuration that indicates a TCI state and at least two substates (e.g., TCI substates 330) for the TCI state, wherein a first substate of the at least two substates corresponds to the discrete antenna mode and a second substate of the at least two substates corresponds to the modular antenna mode.

In a second aspect, alone or in combination with the first aspect, process 500 includes switching from the modular antenna mode to the discrete antenna mode in accordance with the message indicating the first substate of the TCI state.

In a third aspect, alone or in combination with one or more of the first and second aspects, process 500 includes switching from the discrete antenna mode to the modular antenna mode in accordance with the message indicating the second substate of the TCI state.

In a fourth aspect, alone or in combination with one or more of the first through third aspects, the first substate and the second substate both correspond to a same quasi co-located reference signal source.

In a fifth aspect, alone or in combination with one or more of the first through fourth aspects, process 500 includes transmitting, to the UE, a TCI state configuration that indicates a first set of one or more TCI states (e.g., a first TCI state list 335) and a second set of one or more TCI states (e.g., a second TCI state list 335), wherein the first set of one or more TCI states corresponds to the discrete antenna mode and the second set of one or more TCI states corresponds to the modular antenna mode.

In a sixth aspect, alone or in combination with one or more of the first through fifth aspects, process 500 includes switching from the modular antenna mode to the discrete antenna mode in accordance with the message indicating a first TCI state of the first set of one or more TCI states.

In a seventh aspect, alone or in combination with one or more of the first through sixth aspects, process 500 includes switching from the discrete antenna mode to the modular antenna mode in accordance with the message indicating a first TCI state of the second set of one or more TCI states.

In an eighth aspect, alone or in combination with one or more of the first through seventh aspects, the capability message indicates a first duration for switching from the discrete antenna mode to the modular antenna mode and a second duration for switching from the modular antenna mode to the discrete antenna mode. In some examples, to indicate the first duration and the second duration, the capability message indicates one or more absolute time durations, one or more quantities of symbols associated with a subcarrier spacing, or a combination thereof.

In a ninth aspect, alone or in combination with one or more of the first through eighth aspects, process 500 includes transmitting, to the UE, a PDCCH message via a CORESET corresponding to the discrete antenna mode, wherein the PDCCH message schedules a PDSCH message in accordance with the modular antenna mode, and transmitting, to the UE after the first duration from transmitting the PDCCH message, the PDSCH message while operating in the modular antenna mode.

In a tenth aspect, alone or in combination with one or more of the first through ninth aspects, process 500 includes transmitting, to the UE, a PDCCH message via a CORESET corresponding to the modular antenna mode, wherein the PDCCH message schedules a PDSCH message in accordance with the discrete antenna mode, and transmitting, to the UE after the second duration from transmitting the PDCCH message, the PDSCH message while operating in the discrete antenna mode.

In an eleventh aspect, alone or in combination with one or more of the first through tenth aspects, process 500 includes transmitting, to the UE, one or more reference signals via a CORESET corresponding to one of the discrete antenna mode or the modular antenna mode, and switching between the discrete antenna mode and the modular antenna mode in accordance with a RSRP associated with the one or more reference signals satisfying a threshold.

In a twelfth aspect, alone or in combination with one or more of the first through eleventh aspects, the capability message indicates at least one of a quantity of the one or more discrete antennas of the UE, and a quantity of the one or more antenna elements of the UE, or a quantity of one or more antenna modules of the UE.

In a thirteenth aspect, alone or in combination with one or more of the first through twelfth aspects, process 500 includes transmitting, to the UE, a configuration indicating a plurality of SRS resources, wherein each SRS resource of the plurality of SRS resources corresponds to at least one of a respective uplink TCI state or a substate for the respective uplink TCI state, and receiving, from the UE, an SRS via a first SRS resource of the plurality of SRS resources while operating in one of the modular antenna mode or the discrete antenna mode in accordance with at least one of a first TCI state corresponding to the first SRS resource or a substate of the first TCI state.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE (e.g., a UE 120), or a UE may include the apparatus 600. In some aspects, the apparatus 600 includes a reception component 602, a transmission component 604, or a communication manager 606, which may be in communication with one another (for example, via one or more buses or one or more other components). In some aspects, the communication manager 606 is the communication manager 150 described in connection with FIG. 1. As shown, the apparatus 600 may communicate with another apparatus 608, such as a UE or a network node (such as a network node 110, CU, a DU, an RU, or a base station), using the reception component 602 and the transmission component 604. The communication manager 606 may be included in, or implemented via, a processing system (for example, the processing system 140 described in connection with FIG. 1) of the UE.

In some aspects, the apparatus 600 may be configured to perform one or more operations described herein in connection with FIGS. 2-3. Additionally, or alternatively, the apparatus 600 may be configured to perform one or more processes described herein, such as process 400 of FIG. 4. In some aspects, the apparatus 600 or one or more components shown in FIG. 6 may include one or more components of the UE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 608. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the UE described above in connection with FIG. 1, such as a radio, one or more RF chains, one or more transceivers, or one or more modems, each of which may in turn be coupled with one or more antennas of the UE.

The transmission component 604 may transmit communications, such as reference signals, control information, data communications, or a combination thereof, to the apparatus 608. In some aspects, one or more other components of the apparatus 600 may generate communications and may provide the generated communications to the transmission component 604 for transmission to the apparatus 608. In some aspects, the transmission component 604 may perform signal processing on the generated communications, and may transmit the processed signals to the apparatus 608. In some aspects, the transmission component 604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 604 may be co-located with the reception component 602.

The communication manager 606 may support operations of the reception component 602 or the transmission component 604. For example, the communication manager 606 may receive information associated with configuring reception of communications by the reception component 602 or transmission of communications by the transmission component 604. Additionally, or alternatively, the communication manager 606 may generate or provide control information to the reception component 602 or the transmission component 604 to control reception or transmission of communications.

The transmission component 604 may transmit, to a network node, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications. The reception component 602 may receive, from the network node, a message indicating a switch between the discrete antenna mode and the modular antenna mode in accordance with the capability message. The reception component 602 or the transmission component 604 may communicate with the network node in accordance with the switch between the discrete antenna mode and the modular antenna mode.

The reception component 602 may receive, from the network node, a TCI state configuration that indicates a TCI state and at least two substates for the TCI state, wherein a first substate of the at least two substates corresponds to the discrete antenna mode and a second substate of the at least two substates corresponds to the modular antenna mode.

The communication manager 606 may switch from the modular antenna mode to the discrete antenna mode in accordance with the message indicating the first substate of the TCI state.

The communication manager 606 may switch from the discrete antenna mode to the modular antenna mode in accordance with the message indicating the second substate of the TCI state.

The reception component 602 may receive, from the network node, a TCI state configuration that indicates a first set of one or more TCI states and a second set of one or more TCI states, wherein the first set of one or more TCI states corresponds to the discrete antenna mode and the second set of one or more TCI states corresponds to the modular antenna mode.

The communication manager 606 may switch from the modular antenna mode to the discrete antenna mode in accordance with the message indicating a first TCI state of the first set of one or more TCI states.

The communication manager 606 may switch from the discrete antenna mode to the modular antenna mode in accordance with the message indicating a first TCI state of the second set of one or more TCI states.

The reception component 602 may receive a PDCCH message via a CORESET corresponding to the discrete antenna mode, wherein the PDCCH message schedules a PDSCH message in accordance with the modular antenna mode receiving, from the network node after the first duration from receiving the PDCCH message, the PDSCH message while operating in the modular antenna mode.

The reception component 602 may receive, from the network node, a PDCCH message via a CORESET corresponding to the modular antenna mode, wherein the PDCCH message schedules a PDSCH message in accordance with the discrete antenna mode receiving, from the network node after the second duration from receiving the PDCCH message, the PDSCH message while operating in the discrete antenna mode.

The reception component 602 may receive, from the network node, one or more reference signals via a CORESET corresponding to one of the discrete antenna mode or the modular antenna mode switching between the discrete antenna mode and the modular antenna mode in accordance with an RSRP associated with the one or more reference signals satisfying a threshold.

The reception component 602 may receive, from the network node, a configuration indicating a plurality of SRS resources, wherein each SRS resource of the plurality of SRS resources corresponds to at least one of a respective uplink TCI state or a substate for the respective uplink TCI state transmitting, to the network node, an SRS via a first SRS resource of the plurality of SRS resources while operating in one of the modular antenna mode or the discrete antenna mode in accordance with at least one of a first TCI state corresponding to the first SRS resource or a substate of the first TCI state.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication. The apparatus 700 may be a network node (e.g., a network node 110), or a network node may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 155 described in connection with FIG. 1. As shown, the apparatus 700 may communicate with another apparatus 708, such as a UE (e.g., a UE 120) or a network node (such as a CU, a DU, an RU, or a base station), using the reception component 702 and the transmission component 704. The communication manager 706 may be included in, or implemented via, a processing system (for example, the processing system 145 described in connection with FIG. 1) of the network node.

In some aspects, the apparatus 700 may be configured to perform one or more operations described herein in connection with FIGS. 2-3. Additionally, or alternatively, the apparatus 700 may be configured to perform one or more processes described herein, such as process 500 of FIG. 5. In some aspects, the apparatus 700 or one or more components shown in FIG. 7 may include one or more components of the network node described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the network node described above in connection with FIG. 1, such as a radio, one or more RF chains, one or more transceivers, or one or more modems, each of which may in turn be coupled with one or more antennas of the network node. In some aspects, the reception component 702 or the transmission component 704 may include or may be included in a network interface. The network interface may be configured to obtain or output signals for the apparatus 700 via one or more communications links, such as a backhaul link, a midhaul link, or a fronthaul link.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive, from a UE, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications. The transmission component 704 may transmit, to the UE, a message indicating a switch between the discrete antenna mode and the modular antenna mode in accordance with the capability message. The reception component 702 or the transmission component 704 may communicate with the UE in accordance with the switch between the discrete antenna mode and the modular antenna mode.

The transmission component 704 may transmit, to the UE, a TCI state configuration that indicates a TCI state and at least two substates for the TCI state, wherein a first substate of the at least two substates corresponds to the discrete antenna mode and a second substate of the at least two substates corresponds to the modular antenna mode.

The communication manager 706 may switch from the modular antenna mode to the discrete antenna mode in accordance with the message indicating the first substate of the TCI state.

The communication manager 706 may switch from the discrete antenna mode to the modular antenna mode in accordance with the message indicating the second substate of the TCI state.

The transmission component 704 may transmit, to the UE, a TCI state configuration that indicates a first set of one or more TCI states and a second set of one or more TCI states, wherein the first set of one or more TCI states corresponds to the discrete antenna mode and the second set of one or more TCI states corresponds to the modular antenna mode.

The communication manager 706 may switch from the modular antenna mode to the discrete antenna mode in accordance with the message indicating a first TCI state of the first set of one or more TCI states.

The communication manager 706 may switch from the discrete antenna mode to the modular antenna mode in accordance with the message indicating a first TCI state of the second set of one or more TCI states.

The transmission component 704 may transmit, to the UE, a PDCCH message via a CORESET corresponding to the discrete antenna mode, wherein the PDCCH message schedules a PDSCH message in accordance with the modular antenna mode.

The transmission component 704 may transmit, to the UE after the first duration from transmitting the PDCCH message, the PDSCH message while operating in the modular antenna mode.

The transmission component 704 may transmit, to the UE, a PDCCH message via a CORESET corresponding to the modular antenna mode, wherein the PDCCH message schedules a PDSCH message in accordance with the discrete antenna mode.

The transmission component 704 may transmit, to the UE after the second duration from transmitting the PDCCH message, the PDSCH message while operating in the discrete antenna mode.

The transmission component 704 may transmit, to the UE, one or more reference signals via a CORESET corresponding to one of the discrete antenna mode or the modular antenna mode.

The communication manager 706 may switch between the discrete antenna mode and the modular antenna mode in accordance with an RSRP associated with the one or more reference signals satisfying a threshold.

The transmission component 704 may transmit, to the UE, a configuration indicating a plurality of SRS resources, wherein each SRS resource of the plurality of SRS resources corresponds to at least one of a respective uplink TCI state or a substate for the respective uplink TCI state.

The reception component 702 may receive, from the UE, an SRS via a first SRS resource of the plurality of SRS resources while operating in one of the modular antenna mode or the discrete antenna mode in accordance with at least one of a first TCI state corresponding to the first SRS resource or a substate of the first TCI state.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed by a UE, comprising: transmitting, to a network node, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications; receiving, from the network node, a message indicating a switch between the discrete antenna mode and the modular antenna mode in accordance with the capability message; and communicating with the network node in accordance with the switch between the discrete antenna mode and the modular antenna mode.
Aspect 2: The method of Aspect 1, further comprising: receiving, from the network node, a TCI state configuration that indicates a TCI state and at least two substates for the TCI state, wherein a first substate of the at least two substates corresponds to the discrete antenna mode and a second substate of the at least two substates corresponds to the modular antenna mode.
Aspect 3: The method of Aspect 2, further comprising: switching from the modular antenna mode to the discrete antenna mode in accordance with the message indicating the first substate of the TCI state.
Aspect 4: The method of Aspect 2, further comprising: switching from the discrete antenna mode to the modular antenna mode in accordance with the message indicating the second substate of the TCI state.
Aspect 5: The method of any of Aspects 2-4, wherein the first substate and the second substate both correspond to a same quasi co-located reference signal source.
Aspect 6: The method of any of Aspects 1-5, further comprising: receiving, from the network node, a TCI state configuration that indicates a first set of one or more TCI states and a second set of one or more TCI states, wherein the first set of one or more TCI states corresponds to the discrete antenna mode and the second set of one or more TCI states corresponds to the modular antenna mode.
Aspect 7: The method of Aspect 6, further comprising: switching from the modular antenna mode to the discrete antenna mode in accordance with the message indicating a first TCI state of the first set of one or more TCI states.
Aspect 8: The method of Aspect 6, further comprising: switching from the discrete antenna mode to the modular antenna mode in accordance with the message indicating a first TCI state of the second set of one or more TCI states.
Aspect 9: The method of any of Aspects 1-8, wherein the capability message indicates a first duration for switching from the discrete antenna mode to the modular antenna mode and a second duration for switching from the modular antenna mode to the discrete antenna mode.
Aspect 10: The method of Aspect 9, further comprising: receiving a PDCCH message via a CORESET corresponding to the discrete antenna mode, wherein the PDCCH message schedules a PDSCH message in accordance with the modular antenna mode; and receiving, from the network node after the first duration from receiving the PDCCH message, the PDSCH message while operating in the modular antenna mode.
Aspect 11: The method of Aspect 9, further comprising: receiving, from the network node, a PDCCH message via a CORESET corresponding to the modular antenna mode, wherein the PDCCH message schedules a PDSCH message in accordance with the discrete antenna mode; and receiving, from the network node after the second duration from receiving the PDCCH message, the PDSCH message while operating in the discrete antenna mode.
Aspect 12: The method of any of Aspects 9-11, wherein, to indicate the first duration and the second duration, the capability message indicates one or more absolute time durations, one or more quantities of symbols associated with a subcarrier spacing, or a combination thereof.
Aspect 13: The method of any of Aspects 1-12, further comprising: receiving, from the network node, one or more reference signals via a CORESET corresponding to one of the discrete antenna mode or the modular antenna mode; and switching between the discrete antenna mode and the modular antenna mode in accordance with an RSRP associated with the one or more reference signals satisfying a threshold.
Aspect 14: The method of any of Aspects 1-13, wherein the capability message indicates at least one of a quantity of the one or more discrete antennas of the UE, and a quantity of the one or more antenna elements of the UE, or a quantity of one or more antenna modules of the UE.
Aspect 15: The method of any of Aspects 1-14, further comprising: receiving, from the network node, a configuration indicating a plurality of SRS resources, wherein each SRS resource of the plurality of SRS resources corresponds to at least one of a respective uplink TCI state or a substate for the respective uplink TCI state; and transmitting, to the network node, an SRS via a first SRS resource of the plurality of SRS resources while operating in one of the modular antenna mode or the discrete antenna mode in accordance with at least one of a first TCI state corresponding to the first SRS resource or a substate of the first TCI state.
Aspect 16: A method of wireless communication performed by a network node, comprising: receiving, from a UE, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications; transmitting, to the UE, a message indicating a switch between the discrete antenna mode and the modular antenna mode in accordance with the capability message; and communicating with the UE in accordance with the switch between the discrete antenna mode and the modular antenna mode.
Aspect 17: The method of Aspect 16, further comprising: transmitting, to the UE, a TCI state configuration that indicates a TCI state and at least two substates for the TCI state, wherein a first substate of the at least two substates corresponds to the discrete antenna mode and a second substate of the at least two substates corresponds to the modular antenna mode.
Aspect 18: The method of Aspect 17, further comprising: switching from the modular antenna mode to the discrete antenna mode in accordance with the message indicating the first substate of the TCI state.
Aspect 19: The method of Aspect 17, further comprising: switching from the discrete antenna mode to the modular antenna mode in accordance with the message indicating the second substate of the TCI state.
Aspect 20: The method of any of Aspects 17-19, wherein the first substate and the second substate both correspond to a same quasi co-located reference signal source.
Aspect 21: The method of any of Aspects 16-20, further comprising: transmitting, to the UE, a TCI state configuration that indicates a first set of one or more TCI states and a second set of one or more TCI states, wherein the first set of one or more TCI states corresponds to the discrete antenna mode and the second set of one or more TCI states corresponds to the modular antenna mode.

Aspect 22: The method of Aspect 21, further comprising: switching from the modular antenna mode to the discrete antenna mode in accordance with the message indicating a first TCI state of the first set of one or more TCI states.

Aspect 23: The method of Aspect 21, further comprising: switching from the discrete antenna mode to the modular antenna mode in accordance with the message indicating a first TCI state of the second set of one or more TCI states.

Aspect 24: The method of any of Aspects 16-23, wherein the capability message indicates a first duration for switching from the discrete antenna mode to the modular antenna mode and a second duration for switching from the modular antenna mode to the discrete antenna mode.

Aspect 25: The method of Aspect 24, further comprising: transmitting, to the UE, a PDCCH message via a CORESET corresponding to the discrete antenna mode, wherein the PDCCH message schedules a PDSCH message in accordance with the modular antenna mode; and transmitting, to the UE after the first duration from transmitting the PDCCH message, the PDSCH message while operating in the modular antenna mode.

Aspect 26: The method of Aspect 24, further comprising: transmitting, to the UE, a PDCCH message via a CORESET corresponding to the modular antenna mode, wherein the PDCCH message schedules a PDSCH message in accordance with the discrete antenna mode; and transmitting, to the UE after the second duration from transmitting the PDCCH message, the PDSCH message while operating in the discrete antenna mode.

Aspect 27: The method of any of Aspects 24-26, wherein, to indicate the first duration and the second duration, the capability message indicates one or more absolute time durations, one or more quantities of symbols associated with a subcarrier spacing, or a combination thereof.

Aspect 28: The method of any of Aspects 16-27, further comprising: transmitting, to the UE, one or more reference signals via a CORESET corresponding to one of the discrete antenna mode or the modular antenna mode; and switching between the discrete antenna mode and the modular antenna mode in accordance with an RSRP associated with the one or more reference signals satisfying a threshold.

Aspect 29: The method of any of Aspects 16-28, wherein the capability message indicates at least one of a quantity of the one or more discrete antennas of the UE, and a quantity of the one or more antenna elements of the UE, or a quantity of one or more antenna modules of the UE.

Aspect 30: The method of any of Aspects 16-29, further comprising: transmitting, to the UE, a configuration indicating a plurality of SRS resources, wherein each SRS resource of the plurality of SRS resources corresponds to at least one of a respective uplink TCI state or a substate for the respective uplink TCI state; and receiving, from the UE, an SRS via a first SRS resource of the plurality of SRS resources while operating in one of the modular antenna mode or the discrete antenna mode in accordance with at least one of a first TCI state corresponding to the first SRS resource or a substate of the first TCI state.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

Aspect 38: A device comprising a processing system that includes one or more processors and one or more code-storing memories coupled with the one or more processors, the processing system configured to cause the device to perform the method of one or more of Aspects 1-30.

Aspect 39: A device comprising a processing system that includes processor circuitry and code-storing memory circuitry, the processing system configured to cause the device to perform the method of one or more of Aspects 1-30.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A method of wireless communication performed by a user equipment (UE), comprising:
transmitting, to a network node, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications;
receiving, from the network node, a message indicating a switch between the discrete antenna mode and the modular antenna mode in accordance with the capability message; and
communicating with the network node in accordance with the switch between the discrete antenna mode and the modular antenna mode.

2. The method of claim 1, further comprising:
receiving, from the network node, a transmission configuration indicator (TCI) state configuration that indicates a TCI state and at least two substates for the TCI state, wherein a first substate of the at least two substates corresponds to the discrete antenna mode and a second substate of the at least two substates corresponds to the modular antenna mode.

3. The method of claim 2, further comprising:
switching from the modular antenna mode to the discrete antenna mode in accordance with the message indicating the first substate of the TCI state.

4. The method of claim 2, further comprising:
switching from the discrete antenna mode to the modular antenna mode in accordance with the message indicating the second substate of the TCI state.

5. The method of claim 2, wherein the first substate and the second substate both correspond to a same quasi co-located reference signal source.

6. The method of claim 1, further comprising:
receiving, from the network node, a transmission configuration indicator (TCI) state configuration that indicates a first set of one or more TCI states and a second set of one or more TCI states, wherein the first set of one or more TCI states corresponds to the discrete antenna mode and the second set of one or more TCI states corresponds to the modular antenna mode.

7. The method of claim 1, wherein the capability message indicates a first duration for switching from the discrete antenna mode to the modular antenna mode and a second duration for switching from the modular antenna mode to the discrete antenna mode.

8. The method of claim 7, further comprising:
receiving a physical downlink control channel (PDCCH) message via a control resource set (CORESET) corresponding to the discrete antenna mode, wherein the PDCCH message schedules a physical downlink shared channel (PDSCH) message in accordance with the modular antenna mode; and
receiving, from the network node after the first duration from receiving the PDCCH message, the PDSCH message while operating in the modular antenna mode.

9. The method of claim 7, further comprising:
receiving, from the network node, a physical downlink control channel (PDCCH) message via a control resource set (CORESET) corresponding to the modular antenna mode, wherein the PDCCH message schedules a physical downlink shared channel (PDSCH) message in accordance with the discrete antenna mode; and
receiving, from the network node after the second duration from receiving the PDCCH message, the PDSCH message while operating in the discrete antenna mode.

10. The method of claim 7, wherein, to indicate the first duration and the second duration, the capability message indicates one or more absolute time durations, one or more quantities of symbols associated with a subcarrier spacing, or a combination thereof.

11. The method of claim 1, further comprising:
receiving, from the network node, one or more reference signals via a control resource set (CORESET) corresponding to one of the discrete antenna mode or the modular antenna mode; and
switching between the discrete antenna mode and the modular antenna mode in accordance with a reference signal received power (RSRP) associated with the one or more reference signals satisfying a threshold.

12. The method of claim 1, further comprising:
receiving, from the network node, a configuration indicating a plurality of sounding reference signal (SRS) resources, wherein each SRS resource of the plurality of SRS resources corresponds to at least one of a respective uplink transmission configuration indicator (TCI) state or a substate for the respective uplink TCI state; and
transmitting, to the network node, an SRS via a first SRS resource of the plurality of SRS resources while operating in one of the modular antenna mode or the discrete antenna mode in accordance with at least one of a first TCI state corresponding to the first SRS resource or a substate of the first TCI state.

13. A user equipment (UE), comprising:
a processing system that includes one or more processors and one or more code-storing memories coupled with the one or more processors, the processing system configured to cause the UE to:
transmit, to a network node, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications;
receive, from the network node, a message indicating a switch between the discrete antenna mode and the modular antenna mode in accordance with the capability message; and
communicate with the network node in accordance with the switch between the discrete antenna mode and the modular antenna mode.

14. The UE of claim 13, wherein the processing system is configured to cause the UE to:
receive, from the network node, a transmission configuration indicator (TCI) state configuration that indicates a TCI state and at least two substates for the TCI state, wherein a first substate of the at least two substates corresponds to the discrete antenna mode and a second substate of the at least two substates corresponds to the modular antenna mode.

15. The UE of claim 13, wherein the processing system is configured to cause the UE to:
receive, from the network node, a transmission configuration indicator (TCI) state configuration that indicates a first set of one or more TCI states and a second set of one or more TCI states, wherein the first set of one or more TCI states corresponds to the discrete antenna mode and the second set of one or more TCI states corresponds to the modular antenna mode.

16. The UE of claim 15, wherein the processing system is configured to cause the UE to:
switch from the modular antenna mode to the discrete antenna mode in accordance with the message indicating a first TCI state of the first set of one or more TCI states.

17. The UE of claim 15, wherein the processing system is configured to cause the UE to:
switch from the discrete antenna mode to the modular antenna mode in accordance with the message indicating a first TCI state of the second set of one or more TCI states.

18. The UE of claim 13, wherein the capability message indicates a first duration for switching from the discrete antenna mode to the modular antenna mode and a second duration for switching from the modular antenna mode to the discrete antenna mode.

19. The UE of claim 13, wherein the capability message indicates at least one of a quantity of the one or more discrete antennas of the UE, and a quantity of the one or more antenna elements of the UE, or a quantity of one or more antenna modules of the UE.

20. A non-transitory computer-readable medium storing a set of instructions for wireless communication, the set of instructions comprising:
one or more instructions that, when executed by one or more processors of a user equipment (UE), cause the UE to:
transmit, to a network node, a capability message indicating support for switching between a discrete antenna mode and a modular antenna mode, wherein the discrete antenna mode is associated with using one or more discrete antennas of the UE for communications and the modular antenna mode is associated with using one or more antenna elements in an antenna module of the UE for communications;
receive, from the network node, a message indicating a switch between the discrete antenna mode and the modular antenna mode in accordance with the capability message; and
communicate with the network node in accordance with the switch between the discrete antenna mode and the modular antenna mode.
